(19) United States
(12) Patent Application Publication
(10) Pub. No.: US 2016/0378252 A1
(43) Pub. Date: Dec. 29, 2016

(54) Apparatus and Method for Detecting Touch

(71) Applicant: CRUCIAL TEC CO., LTD., Chungcheongnam-do (KR)

(72) Inventors: Byung Chul Jeong, Seoul (KR); Dong Woon Kim, Seoul (KR)

(21) Appl. No.: 14/901,567

(22) PCT Filed: May 27, 2014
(86) PCT No.: PCT/KR2014/004694

§ 371 Date: Dec. 28, 2015

(30) Foreign Application Priority Data
Jun. 27, 2013 (KR) 10-2013-0074798
Jun. 27, 2013 (KR) 10-2013-0074799

(51) Int. Cl. G06F 3/041; G06F 3/044

(52) U.S. Cl. CPC G06F 3/0418; G06F 3/044

(57) ABSTRACT

One embodiment of the present invention provides an apparatus for detecting a touch, the apparatus comprising: a sensor pad for forming touch capacitance in relation to a touch input tool; an operation amplifier for outputting different signals according to whether there is a touch on the sensor pad, the operation amplifier having a first input end connected to the sensor pad and a second input end receiving a reference voltage; a first switch for controlling potentials of both ends of driving capacitance connected between the first input end and an output end of the operation amplifier; a second switch for switching a connection between the sensor pad and the first input end, the second switch being turned on and off alternately with the first switch; and a parasitic capacitance compensation circuit for supplying an electric charge to at least one of the touch capacitance and parasitic capacitance that shares a charge amount of the touch capacitance when the second switch is in an on state.

### TECHNICAL FIELD

The present invention relates to an apparatus and method for detecting touch, more specifically to an apparatus and method for detecting touch minimizing the effect for parasitic capacitance while securing linearity.

### BACKGROUND ART

A touchscreen panel is a device for inputting user command by touching letters or diagrams displayed on the screen of an image display device with a human finger or other touch means, which is used attached to an image display device. The touchscreen panel converts the touch location touched with the human finger, etc. into electrical signals. The electrical signal is used as an input signal.

FIG. 1 is an exploded plan view of an embodiment of the capacitive touchscreen panel according to conventional art.

Referring to FIG. 1, a touchscreen panel 10 includes a transparent substrate 12, and a first sensor pattern layer 13, a first insulating layer 14, a second sensor pattern layer 15, and a second insulating layer 16 formed in order on the transparent substrate 12, and a metal wiring 17.

The first sensor pattern layer 13 may be connected along the lateral direction on the transparent substrate 12, and may be connected with the metal wiring 17 in the unit of rows.

The second sensor pattern layer 15 may be connected along the longitudinal direction on the first insulating layer 14, and disposed alternately with the first sensor pattern layer 13 so as not to overlap with the first sensor pattern layer 13. Also, the second sensor pattern layer 15 is connected with the metal wiring 17 in the unit of columns.

When a human finger or touch means touches the touchscreen panel 10, the change in capacitance according to touch location is delivered to the driving circuit through the first and second sensor pattern layers 13 and 15, and metal wiring 17. Also, the touch location is identified as the change in capacitance delivered as above is converted into an electrical signal.

However, each sensor pattern layer 13 and 15 of the touchscreen panel 10 should have a pattern made of transparent conductive materials such as indium-tin oxide (ITO), separately, and there should be an insulating layer 14 between the sensor pattern layers 13 and 15. Accordingly, the thickness increases.

Also, since touch may be detected only after accumulating the minute changes in capacitance generated by touch several times, the change in capacitance is to be detected with high frequency. Further, in order to accumulate enough change in capacitance within a predetermined time, a metal wiring for maintaining low resistance is required. However, such metal wiring makes the bezel at the edge of the touchscreen thick and causes an additional mask process to occur.

In order to solve this problem, an apparatus for detecting touch was suggested as illustrated in FIG. 2.

The apparatus for detecting touch illustrated in FIG. 2 includes a touch panel 20, a driving device 30, and a circuit board 40 connecting the two.

The touch panel 20 is formed on a substrate 21, and includes a plurality of sensor pads 22 arranged in the form of a polygonal matrix, and a plurality of signal wirings 23 connected with the sensor pad 22.

For each signal wiring 23, one end is connected with a sensor pad 22 and the other end protrudes to the lower edge of the substrate 21. The sensor pad 22 and signal wiring 23 may be patterned on the cover glass 50.

The driving device 30 selects one of the plurality of sensor pads 22 after the other, and measures the capacitance of the corresponding sensor pad 22. Accordingly, it detects whether touch is made.

When a touch is made, touch capacitance is formed between the touch generation tool (for example, a finger) and sensor pad 22. When a predetermined signal is inputted to the sensor pad 22, an output signal from the sensor pad may vary depending on whether there is touch capacitance. The driving device 30 determines whether there is touch through the output signal from the sensor pad 22.

FIG. 3 is a circuit diagram for explaining the operation of an apparatus for detecting touch according to an embodiment of the present invention.

Referring to FIG. 3, the apparatus for detecting touch may include a sensor pad 22, driving capacitance Cdrv, an operation amplifier OP-amp, and an analogue-digital converter ADC. The driving capacitance Cdrv, operation amplifier OP-amp and analogue-digital converter ADC are components included in the driving device 30 in FIG. 2.

A first input end of the operation amplifier OP-amp is connected to an output of the sensor pad 22, and a reference voltage Vref is applied to a second input end. Driving capacitance Cdrv is connected between the first input end and an output end of the operation amplifier OP-amp, and potential at both ends of the driving capacitance Cdrv is controlled by a first switch SW1. A second switch SW2 is connected between the first input end of the operation amplifier OP-amp and the output end of the sensor pad 22.

The first switch SW1 and the second switch SW2 are turned on and off alternately. When the first switch SW1 is turned on, touch capacitance Ct between the sensor pad 22 and the touch generation tool is connected to a ground voltage. Additionally, both ends of parasitic capacitance Cp formed by the sensor pad 22 or a signal wiring, etc. are also connected to the ground voltage. As the first switch SW1 is turned on, the touch capacitance Ct, parasitic capacitance Cp, driving capacitance Cdrv are reset, and potential at both ends of the driving capacitance Cdrv become the same as the reference voltage Vref.

When the first switch SW1 is turned off, and the second switch SW2 is converted into an on state and reaches a steady state, both touch capacitance Ct and parasitic capacitance Cp become charged with reference voltage Vref. The same amount of charge as the sum of charge charged in the touch capacitance Ct and the parasitic capacitance Cp by the operation amplifier OP-amp is charged in driving capacitance Cdrv. This may be expressed in an equation as below.

V_{ref}(Cₜ+Cₚ)=V_{drv}×C_{drv} Equation 1

The left side of equation 1 shows the sum of the amount of charge charged in the touch capacitance Ct and parasitic capacitance Cp, and the right side shows the amount of charge charged in the driving capacitance Cdrv.

According to equation 1, voltages at both ends of the driving capacitance Cdrv may be expressed as below.

$${V}_{drv} = \frac{{V}_{ref} ( {C}_{t} + {C}_{p} )}{{C}_{drv}} \qquad Equation 2$$

A potential difference at both ends of the driving capacitance Cdrv before the second switch is turned on is 0V. Thus, the change in voltage ΔVo of the output end of the operation amplifier OP-amp before and after touch becomes the same as the voltage Vdrv at both ends of the driving capacitance Cdrv.

Since the driving capacitance Cdrv and the reference voltage Vref have predetermined values, the change in voltage ΔVo of the output end of the operation amplifier OP-amp, that is, a level shift value is proportional to the touch capacitance Ct, thereby securing linearity in touch detection.

However, as can be known from Equation 2, the parasitic capacitance Cp as well as the touch capacitance Ct also affects detection on whether there is touch. Thus, the accuracy in touch detection decreases.

Thus, it is necessary to develop a technique for minimizing the effect of parasitic capacitance while securing linearity between the level shift value and touch capacitance before and after touch.

### SUMMARY OF INVENTION

### DISCLOSURE

### Technical Problem

The task to be solved by the present invention is to provide an apparatus and method for detecting touch with a minimized effect of parasitic capacitance while securing linearity between a level shift value and touch capacitance.

### Technical Solution

In order to achieve the above purpose, according to an embodiment of the present invention, an apparatus for detecting touch is provided, which includes a sensor pad for forming touch capacitance in relation to a touch input tool, an operation amplifier for outputting different signals according to whether there is touch on the sensor pad, the operation amplifier having a first input end connected to the sensor pad and a second input end receiving a reference voltage, a first switch for controlling potential of both ends of driving capacitance connected between the first input end and an output end of the operation amplifier, a second switch for switching a connection between the sensor pad and the first input end, the second switch being turned on and off alternately with the first switch, and a parasitic capacitance compensation circuit for supplying an electric charge to at least one of the touch capacitance and parasitic capacitance that shares an amount of charge of the touch capacitance when the second switch is in an on state.

When the second switch is in an on state, the amount of charge supplied by the parasitic capacitance compensation circuit may be the same as an amount of charge charged in the parasitic capacitance.

When the second switch is in an on state, one end of the parasitic capacitance compensation circuit may be connected to the sensor pad and another end may include a feedback capacitance supplying a feedback voltage.

The potential of both ends of the feedback capacitance may be controlled by a third switch synchronized with the first switch.

The size of the feedback capacitance, when touch is not made in the sensor pad, is set not to make a voltage change in the output end of the operation amplifier when the first switch is in an on state and when the second switch is in an on state.

The apparatus for detecting touch may further include a level shift detection unit detecting whether there is touch based on a voltage change at the output end of the operation amplifier.

In order to achieve the above purpose, according to another embodiment of the present invention, an apparatus for detecting touch is provided, which includes a plurality of sensor pads for forming touch capacitance in relation to a touch input tool, and outputting a sensing signal according to touch state, an operation amplifier for outputting different signals based on the sensing signal, the operation amplifier having a first input end connected to the output end of the first sensor pad and a second input end receiving a reference voltage, a first switch for controlling potential of both ends of driving capacitance connected between the first input end and an output end of the operation amplifier, a second switch for switching a connection between the output end of the first sensor pad and the first input end, the second switch being turned on and off alternately with the first switch, and a parasitic capacitance elimination circuit for supplying the same potential as the output end of the first sensor pad to a second sensor pad which is adjacent to the first sensor pad.

The parasitic capacitance elimination circuit may supply the same potential as the potential of the output end of the first sensor pad to the second sensor pad, the parasitic capacitance elimination circuit being synchronized with an on/off of the first switch and the second switch.

The parasitic capacitance elimination circuit may supply a ground voltage and the reference voltage, respectively, to the second sensor pad when the first switch and the second switch are in an on state.

The parasitic capacitance elimination circuit may include a feedback operation amplifier receiving the same signal as the potential of the output end of the first sensor pad to supply it to the second sensor pad.

Meanwhile, according to yet another embodiment of the present invention, a method for detecting touch is provided, which includes resetting a sensor pad, parasitic capacitance connected to the sensor pad, and driving capacitance connected between a first input end of an operation amplifier and an output end, charging at least one of parasitic capacitance connected to the sensor pad and touch capacitance formed between the sensor pad and a touch input tool based on a reference voltage applied to the second input end of the operation amplifier and a feedback voltage of the operation amplifier, and detecting whether there is touch based on a voltage change at the output end of the operation amplifier, in which the charging supplies an electric charge so that the touch capacitance could have the voltage change and linearity irrelevant to the parasitic capacitance.

The charging may compensate charge loss by the parasitic capacitance through feedback capacitance to which the feedback voltage applies, and the reference voltage applied by the operation amplifier may be associated only with the touch capacitance and driving capacitance.

When the feedback voltage is N times the reference voltage, the feedback capacitance may be a divided value of parasitic capacitance by N−1.

According to another embodiment of the present invention, the present invention may include resetting at least one first sensor pad which is the subject of touch detection among a plurality of sensor pads and driving capacitance connected between a first input end and an output end of an operation amplifier, charging the first sensor pad using a reference voltage applied to a second input end of the operation amplifier, and detecting whether there is touch based on a voltage change at the output end of the operation amplifier, in which the resetting and charging, respectively, include supplying the same potential as the output end of the first sensor pad to the second sensor pad which is adjacent to the first sensor pad.

The resetting may include supplying a ground voltage to the second sensor pad, and the charging may include supplying a voltage with the same size as the reference voltage to the second sensor pad.

Also, according to yet another embodiment of the present invention, an apparatus for detecting touch is provided, which includes a sensor pad for forming touch capacitance in a relation with a touch input tool, a first switch which is in an on state only when the sensor pad is reset, the first switch being connected between the sensor pad and a ground terminal, an operation amplifier for outputting a touch detection signal, the operation amplifier having a first input end connected to the sensor pad and a second input end to which a reference voltage is applied, driving capacitance connected between the first input end and the output end of the operation amplifier, a second switch which is in an on state only when the sensor pad is reset, the second switch being connected to both ends of the driving capacitance, feedback capacitance whose one end is connected to the sensor pad and the feedback voltage is applied to another end, a third switch connected between the sensor pad and the first input end of the operation amplifier, the third switch being turned on and off alternately with the first switch and the second switch, a fourth switch connected between the sensor pad and the feedback capacitance, the fourth switch being turned on and off alternately with the first switch and the second switch, and a fifth switch which is in an on state only when the sensor pad is reset, the fifth switch being connected between both ends of the feedback capacitance.

According to another embodiment of the present invention, an apparatus for detecting touch is provided, which includes a plurality of sensor pads for forming touch capacitance in a relation with a touch input tool, and outputting a sensing signal according to touch state, a first switch which is in an on state only when the sensor pad is reset, the first switch being connected between a first sensor pad, which is the subject of touch detection among the plurality of sensor pads, and a ground terminal, an operation amplifier for outputting different signals based on the sensing signal, the operation amplifier having a first input end connected to the first sensor pad and a second input end to which a reference voltage is applied, driving capacitance connected between the first input end and the output end of the operation amplifier, a second switch which is in an on state only when the sensor pad is reset, the second switch being connected to both ends of the driving capacitance, a third switch connected between the sensor pad and the first input end of the operation amplifier, the third switch being turned on and off alternately with the first switch and the second switch, and a feedback operation amplifier where a first input end is connected with the same node as an output end to connect to the second sensor pad which is adjacent to the first sensor pad, and the ground voltage and a voltage with the same potential as the reference voltage are alternately applied to the second input end.

### Advantageous Effects

According to an embodiment of the present invention, a level shift value and touch capacitance, which may be the basis of touch detection, have linearity, thereby easily obtaining an output value of linear relationship. Meanwhile, by minimizing parasitic capacitance generated by a relation between sensor pads, the effect of the parasitic capacitance on touch detection may be prevented.

### DESCRIPTION OF DRAWINGS

FIG. 1 is an exploded plan view of a conventional touch screen panel;

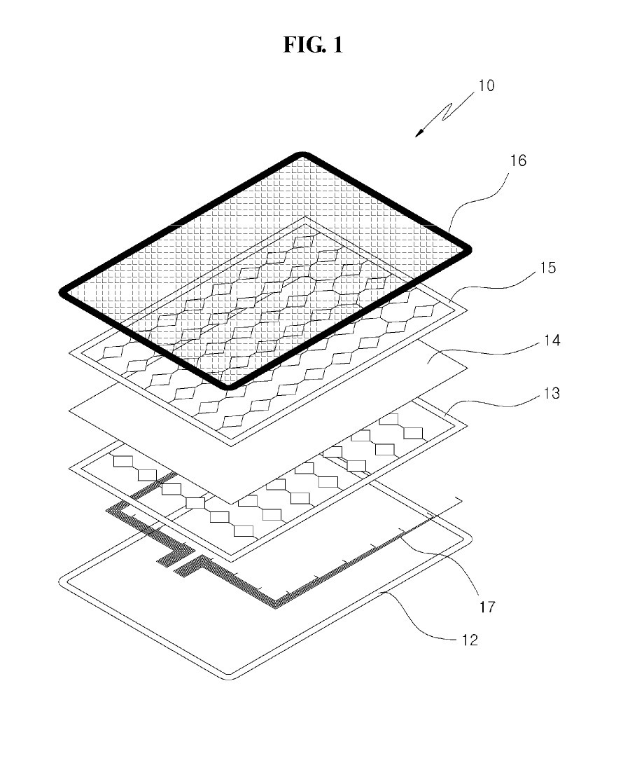

FIG. 2 is an exploded plan view of a conventional apparatus for detecting touch;

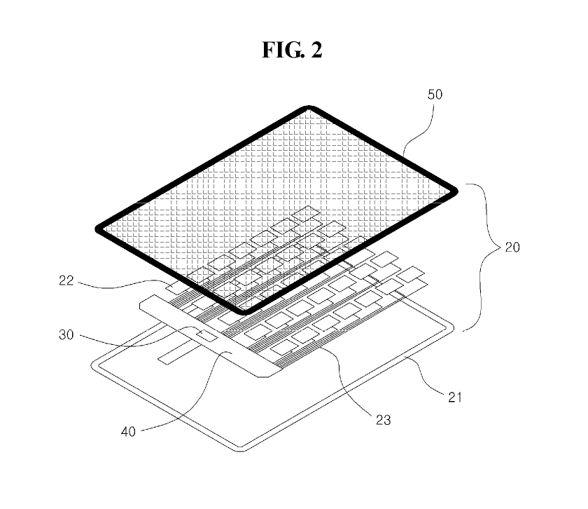

FIG. 3 is a circuit diagram explaining the operation of an apparatus for detecting touch in FIG. 2;

FIG. 4 is a circuit diagram exemplifying an apparatus for detecting touch according to an embodiment of the present invention;

FIG. 5 is a circuit diagram exemplifying an apparatus for detecting touch according to an embodiment of the present invention; and

FIG. 6 is a circuit diagram exemplifying an apparatus for detecting touch according to another embodiment of the present invention.

### MODES OF THE INVENTION

Hereinafter, the terms used in the specification will be briefly described, and then the present invention will be described in detail.

The terms used in the present invention are those general terms currently widely used in the art in consideration of functions in regard to the present invention, but the terms may vary according to the intention of those of ordinary skill in the art, precedents, or new technology in the art. Also, specified terms may be selected by the applicant, and in this case, the detailed meaning thereof will be described in the detailed description of the invention. Thus, the terms used in the specification should be understood not as simple names but based on the meaning of the terms and the overall description of the invention.

Throughout the specification, it will also be understood that when a component “includes” an element, unless there is another opposite description thereto, it should be understood that the component does not exclude another element but may further include another element. In addition, terms such as “ . . . unit,” “ . . . module,” or the like refers to units that perform at least one function or operation, and the units may be implemented as hardware or software or as combination of hardware and software. Further, it will be understood that when an element is referred to as being “connected to” another element, it may be “directly connected to” the other element, or intervening elements or layers may be present.

Hereinafter, examples of the present invention will be explained with reference to the accompanying drawings to an extent to be easily carried out by a person having ordinary skill in the art. The present invention, however, may be modified in various different ways, and should not be construed as limited to the embodiments set forth herein. Also, in order to clearly explain the present disclosure, portions that are not related to the present disclosure are omitted, and like reference numerals are used to refer to like elements throughout.

Hereinafter, examples of the present invention will be explained in detail with reference to the accompanying drawings.

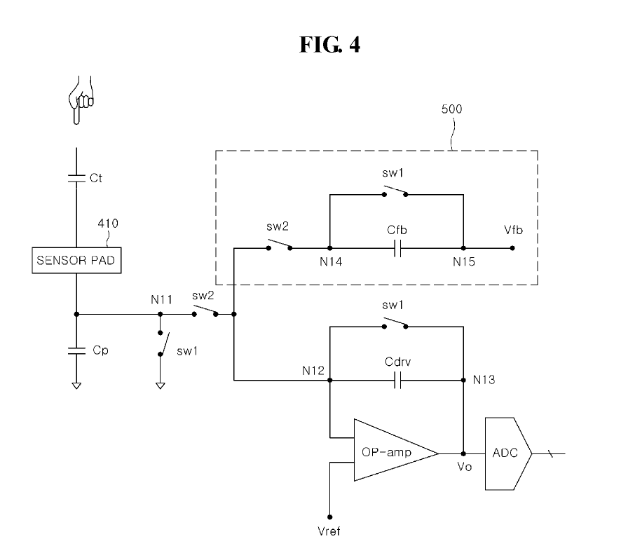

FIG. 4 is a circuit diagram exemplifying an apparatus for detecting touch according to an embodiment of the present invention.

Referring to FIG. 4, the apparatus for detecting touch may include a sensor pad 410, touch capacitance Ct, parasitic capacitance Cp, driving capacitance Cdrv, an operation amplifier OP-amp and an analogue-digital convertor ADC.

The sensor pad 410 may form touch capacitance Ct between touch input tools as an electrode patterned on a substrate for touch input detection. A plurality of sensor pads with polygonal shapes in an independent state may be formed, and they may be formed as transparent conductors. For example, the sensor pads may be made of transparent conductive materials such as indium-tin-oxide (ITO), Antimony Tin Oxide (ATO), indium-zinc-oxide (IZO), carbon nanotube (CNT), graphene, etc.

The parasitic capacitance Cp and driving capacitance Cdrv may form a group for each sensor pad 410 and signal wiring (not illustrated) connected thereto. The sensor pad 410, signal wiring, parasitic capacitance Cp and driving capacitance Cdrv are together called as “a touch sensing unit.” This touch sensing unit is a concept including a case where each component is electrically connected by a multiplexer.

The parasitic capacitance Cp means capacitance which comes with the sensor pad 410, and is a sort of parasitic capacity formed by the sensor pad 410 or signal wiring, etc. The parasitic capacitance Cp may be a concept including capacitance formed between common electrodes of display devices when the apparatus for detecting touch is mounted on the display devices such as LCD, etc.

The driving capacitance Cdrv is capacitance formed in a path supplying a reference voltage Vref to the sensor pad 410. The reference voltage Vref applied to the driving capacitance Cdrv may be a square-wave signal. The reference voltage Vref may be a clock signal with the same duty ratio, but the duty ratio may be different.

A first input end N12 of the operation amplifier OP-amp is connected to an output end N11 of the sensor pad 410, and the reference voltage Vref is applied to the second input end. The driving capacitance Cdrv is connected between the first input end and the output end of the operation amplifier OP-amp, and the voltage at both ends N12 and N13 of the driving capacitance Cdrv is controlled by the first switch SW1. Meanwhile, a second switch SW2 is connected between the first input end N12 of the operation amplifier OP-amp and the output end N11 of the sensor pad 410. Additionally, the output end N13 of the operation amplifier OP-amp is connected to a level shift detection unit. The level shift detection unit may consist of an analogue-digital converter (ADC), a Voltage to Frequency Converter (VFC), a flip-flop, a latch, a buffer, a transistor (TR), a thin film transistor (TFT), a comparator, a Digital to Analog Converter (DAC), an integrator, a differentiator, etc., or may be made by a combination of these components. The level shift detection unit detects whether there is touch based on the voltage change at the output end of the operation amplifier OP-amp which varies depending on touch capacitance.

In the apparatus for detecting touch illustrated in FIG. 4, the first switch SW1 and the second switch SW2 are turned on/off alternately. FIGS. 4 to 6 illustrate a simple switch as an example of switching devices. However, three-terminal devices such as metal oxide semiconductors (MOS), BJT or FET, etc. may be used as another embodiment. When the three-terminal device is used as the switching device, control signals are respectively applied thereto so that a section where the first switch SW1 is turned on does not overlap a section where the second switch SW2 is turned on. As an example, the control signal inputted to a control terminal of the three-terminal device may be set to the extent that the first switch is turned on at a low level section and the second switch is turned on at a high level section.

When the first switch SW1 is turned on, the touch capacitance Ct is connected to a ground terminal, and both ends of the parasitic capacitance Cp are also connected to the ground terminal. In this case, the sensor pad 410 is reset. When the touch is not made in the sensor pad 410, there would be no touch capacitance Ct. However, hereinafter, for the sake of explanation, all embodiments will be explained on the assumption that touch is made in the sensor pad 410 and accordingly, the touch capacitance Ct is formed.

Additionally, the driving capacitance Cdrv is also reset. FIG. 4 exemplifies that the first switch SW1 is connected between both ends N12 and N13 of the driving capacitance Cdrv so that voltage at both ends of the driving capacitance Cdrv becomes 0V when the first switch SW1 is turned on. However, the driving capacitance is connected to a predetermined charging voltage terminal, so it may be initially charged with the charge voltage when the first switch SW1 is turned on.

As can be known from Equation 2, the change in voltage ΔVo at the output end of the operation amplifier OP-amp varies depending on parasitic capacitance Cp. A parasitic capacitance compensation circuit 500 is further arranged in order to minimize the effect caused by the parasitic capacitance Cp and to secure linearity between the level shift value ΔVo and touch capacitance Ct.

The parasitic capacitance compensation circuit 500 according to an embodiment may include feedback capacitance Cfb, and the potential difference of both ends N14 and N15 of the feedback capacitance Cfb is controlled by the first switch SW1. One end N14 of the feedback capacitance Cfb is connected to or blocked from the output end N11 of the sensor pad 410 by the second switch SW2, and feedback voltage Vfb is applied to another end N15.

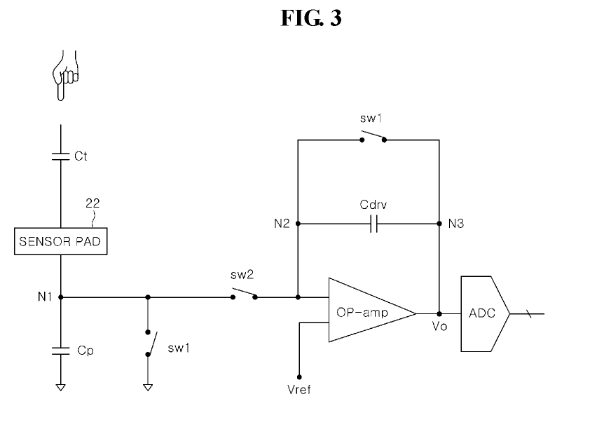

When the first switch SW1 is turned on, and the second switch SW2 is turned off, as explained with reference to FIG. 3, the potential difference between the touch capacitance Ct and both ends of the parasitic capacitance Cp becomes 0V, and thus the charge will not be charged. That is, the sensor pad 410 becomes reset. Additionally, the potential difference of both ends of the driving capacitance Cdrv and the potential difference of both ends of the feedback capacitance Cfb are also 0V, and thus the charge will not be charged in all capacitance. In this case, all potential at both ends N12 and N13 of the driving capacitance Cdrv become the same as the reference voltage Vref, and all potential at both ends N14 and N15 of the feedback capacitance Cfb become the same as the feedback voltage Vfb.

When the first switch SW1 is turned off, and the second switch SW2 is turned on, the potential of the node N11 where the output end of the sensor pad 410 is connected to the second switch becomes the same as the reference voltage Vref. Accordingly, the touch capacitance Ct and the parasitic capacitance Cp are all charged by the reference voltage Vref, and the sum Q1 of the amount of charge charged is the same as the sum of the amount of charge charged in the touch capacitance Ct and parasitic capacitance Cp.

Meanwhile, when the feedback voltage Vfb is greater than the reference voltage Vref (Vfb>Vref), the potential difference is made between both ends N14 and N15 of the feedback capacitance. Specifically, the potential at one end N14 connected to the output end N11 of the sensor pad 410 between both ends of the feedback capacitance becomes lower than the potential at another end N15 to which the feedback voltage Vfb is applied, and accordingly, the feedback capacitance Cfb plays a role of supplying the charge to the apparatus for detecting touch.

The sum Q1 of the amount of charge charged in the touch capacitance Ct and parasitic capacitance Cp becomes the same as the sum Q2 of the amount of charge supplied by the driving capacitance Cdrv and feedback capacitance Cfb. Thus, the following equation may be presented:

Q₁=Q₂

Q₂=(V_{fb}−V_{ref})C_{fb}+V_{drv}C_{drv}

V_{ref}(Cₜ+Cₚ)=(V_{fb}−V_{ref})C_{fb}+V_{drv}C_{drv} Equation 3

Here, assuming that the feedback voltage Vfb is twice the reference voltage Vref, and substituting this, the following equation is made:

V_{ref}(Cₜ+Cₚ)=V_{ref}C_{fb}+V_{drv}C_{drv} Equation 4

Meanwhile, as stated above, the change in voltage at the output end N13 of the operation amplifier OP-amp before and after touch, that is, the level shift value ΔVo is the same as the potential difference Vdrv at both ends of the driving capacitance Cdrv after the second switch SW2 is turned on. Thus, when substituting Vdrv into ΔVo in Equation 4, the following equation is made (Vdrv=ΔVo):

$$Δ {V}_{o} = \frac{{V}_{ref} ( {C}_{t} + {C}_{p} - {C}_{fb} )}{{C}_{drv}} \qquad Equation 5$$

If it is possible to adjust the feedback capacitance Cfb to be the same as the parasitic capacitance Cp in the above equation (Cfb=Cp), the level shift value ΔVo before and after touch may be a value irrelevant to the parasitic capacitance Cp.

That is, when the second switch SW2 is turned on, and a predetermined amount of charge is supplied by properly adjusting the size of feedback capacitance Cfb of the parasitic capacitance compensation circuit 500, the parasitic capacitance may compensate the amount of charge consumed in all parasitic capacitance Cp other than the touch capacitance Ct. Thus, the driving capacitance Cdrv performs the function of charging the touch capacitance Ct only, so the level shift value ΔVo before and after touch is irrelevant to the parasitic capacitance Cp, but is associated only with the touch capacitance Ct.

Meanwhile, in an ideal case, the amount of charge charged in the parasitic capacitance Cp by the reference voltage Vref should be the same as the amount of charge supplied by the feedback capacitance Cfb. Thus, the following equation may be presented:

V_{ref}Cₚ=(V_{fb}−V_{ref})C_{fb} Equation 6

Here, assuming that the feedback capacitance Vfb is an integer multiple of the reference voltage Vref (Vfb=N·Vref), an equation for Cfb may be presented as below.

$${C}_{fb} = \frac{{C}_{p}}{N - 1} \qquad Equation 7$$

Meanwhile, in an actual case, a process for optimizing the size of the feedback capacitance Cfb may be performed as follows: Assuming that the touch capacitance Ct is ‘0,’ and the parasitic capacitance Cp is completely removed, the voltage at the output end of the operation amplifier OP-amp should be the reference voltage Vref, when the first switch SW1 and second switch SW2 are turned on/off alternately. The reason for this is that in an ideal case, there would be no change in the amount of charge charged in an entire apparatus for detecting touch, and in this case, the potential difference Vdrv at both ends of the driving capacitance Cdrv should always be ‘0’ (Vdrv=0).

Thus, when checking the voltage Vo at the output end of the operation amplifier OP-amp or the voltage at the output end of the analogue-digital converter (ADC) while changing the value of the feedback capacitance Cfb, optimized feedback capacitance Cfb may be selected. Parameters of another device, for example, an optimized value may be found while changing the value of the feedback capacitance Cfb only regardless of the driving capacitance Cdrv. Thus, a simple circuit calibration or optimization may be possible.

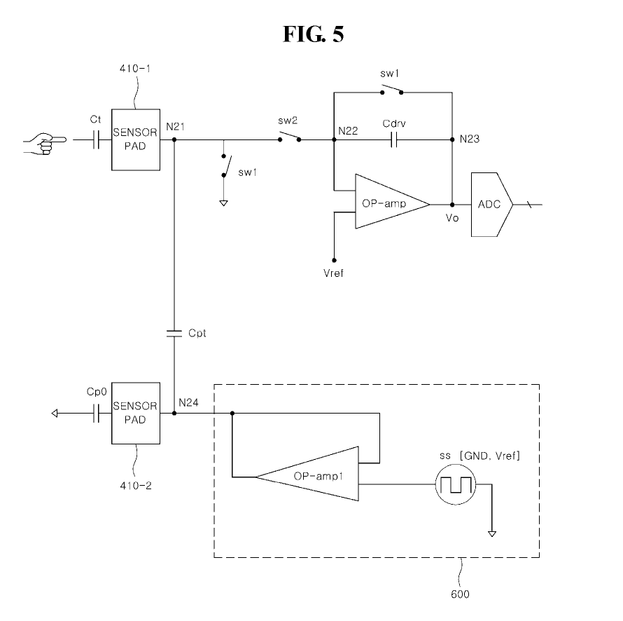

FIG. 5 is a circuit diagram exemplifying an apparatus for detecting touch according to an embodiment of the present invention.

Referring to FIG. 5, it may be known that the parasitic capacitance compensation circuit 500 is omitted in the circuit explained with reference to FIG. 4, and that the parasitic capacitance elimination circuit 600 is added.

The parasitic capacitance existing in the apparatus for detecting touch is formed by various factors. The parasitic capacitance may be formed by a relation between the sensor pads 410-1 and 410-2 and the signal wiring, and may be formed by a relation between the sensor pads 410-1 and 410-2. For example, when the sensor pad 410-1 is a sensor pad currently subject to touch detection, parasitic capacitance (Cpt, hereinafter, ‘first parasitic capacitance’) formed by a relation with a neighboring sensor pad 410-2 may be present. Additionally, parasitic capacitance (Cp0, hereinafter, ‘second parasitic capacitance’) formed by a relation between the sensor pad 410-2 and other circuit configurations may have an effect on detecting whether there is touch in the first sensor pad 410-1.

The parasitic capacitance elimination circuit 600 according to an embodiment of the present invention plays a role of minimizing the first parasitic capacitance Cpt formed by a relation between the sensor pads 410-1 and 410-2, through an operation of adjusting potential between the sensor pad 410-1 currently subject to touch detection and another sensor pad 410-2 to be consistent.

To this end, the parasitic capacitance elimination circuit 600 supplies to another sensor pad 410-2 a different voltage with the same size as the potential at the output end N21 of the sensor pad 410-1 currently subject to touch detection.

As stated above, the first switch SW1 and second switch SW2 of the apparatus for detecting touch are turned on/off alternately. When the first switch SW1 is in an on state, the output end N21 of the sensor pad 410-1 currently subject to touch detection is connected to the ground terminal. Thus, the potential at the output end N11 of the sensor pad 410-1 becomes the same as ground voltage GND.

Meanwhile, when the second switch SW2 is in an on state, the output end N21 of the sensor pad 410-1 currently subject to touch detection is connected to the first input end N22 of the operation amplifier OP-amp. The reference voltage Vref is supplied to the second input end of the operation amplifier OP-amp, so the potential at the output end N21 of the sensor pad 410-1 becomes the same as the reference voltage Vref.

Thus, when the first switch SW1 is in an on state, the ground voltage GND is supplied to another sensor pad 410-2 other than the sensor pad 410-1 currently subject to touch detection, and when the second switch SW2 is in an on state, the reference voltage Vref is supplied to another sensor pad 410-2 other than the sensor pad 410-1 currently subject to touch detection. Then, the potential difference between the adjacent sensor pads may be maintained as 0.

When there are two conductors with a dielectric material therebetween, an amount of charge Q charged in a corresponding structure may be expressed as an equation of Q=CV. Here, C is a capacitance value of the corresponding structure, and V is the potential difference between the two conductors.

In the equation, when the potential difference V of both conductors is converged to be close to 0, an amount of charge Q derived by the potential difference between the conductors may be converged to be close to 0. The capacitance C increases in proportion to the charging ability of charge. Thus, this means that when the amount of charge charged is close to 0, the capacitance C formed by a relation between the conductors is also converged to be close to 0.

Thus, when the potential difference between two sensor pads 410-1 and 410-2 is always controlled to be close to 0, the parasitic capacitance Cpt, which may be generated by a relation between the two sensor pads 410-1 and 410-2, may also be minimized.

The parasitic capacitance elimination circuit 600 controls the potential at the output end of the sensor pads 410-1 and 410-2 to be electrokinetic potential by alternately supplying the ground voltage GND and reference voltage Vref to the sensor pad 410-2 other than the sensor pad 410-1 currently subject to touch detection.

This parasitic capacitance elimination circuit 600 may include a feedback amplifier OP-amp1 where a first input end is connected to the same node N24 as an output. In a second input end of the feedback amplifier OP-amp1, a signal source SS alternately supplying the ground voltage GND and reference voltage Vref may be connected.

As an example, the signal source SS may be a clock signal of a predetermined frequency where a low signal is the ground voltage GND and a high signal is the reference voltage Vref. A clock frequency of the signal source SS should be the same as a switching frequency of the first switch SW1 and second switch SW2. Additionally, when the first switch SW1 is in an on state, synchronization should be made so that a low signal could be outputted. When the second switch SW2 is in an on state, synchronization should be made so that a high signal could be outputted.

Also, as another example, the signal source SS may be implemented with a source of the reference voltage Vref and a switch (not illustrated). The reference voltage Vref is supplied to the second input end of the feedback amplifier OP-amp1, but the supply thereof may be blocked by a predetermined interval through the switch. When the first switch SW1 is in an on state, the supply of the reference voltage Vref is blocked, and when the second switch SW2 is in an on state, the supply of the reference voltage Vref is allowed, and accordingly, the signal source SS may function. In this case, the switch which connects or blocks the second input end of the feedback amplifier OP-amp1 and the reference voltage Vref may be turned on/off in synchronization with the second switch SW2.

For the sake of explanation, FIG. 5 exemplifies that the parasitic capacitance elimination circuit 600 includes the feedback amplifier OP-amp1. However, the feedback amplifier OP-amp1 is a device minimizing transformation of a signal supplied to the second input end and improving stability. Thus, of course, the feedback amplifier OP-amp1 may be omitted, and the signal source SS may be directly connected to the output end N24 of the sensor pad 410-2.

According to an embodiment illustrated in FIG. 5, the parasitic capacitance Cpt generated between adjacent sensor pads are all eliminated in an ideal case, and only another parasitic capacitance Cp0 other than this is left.

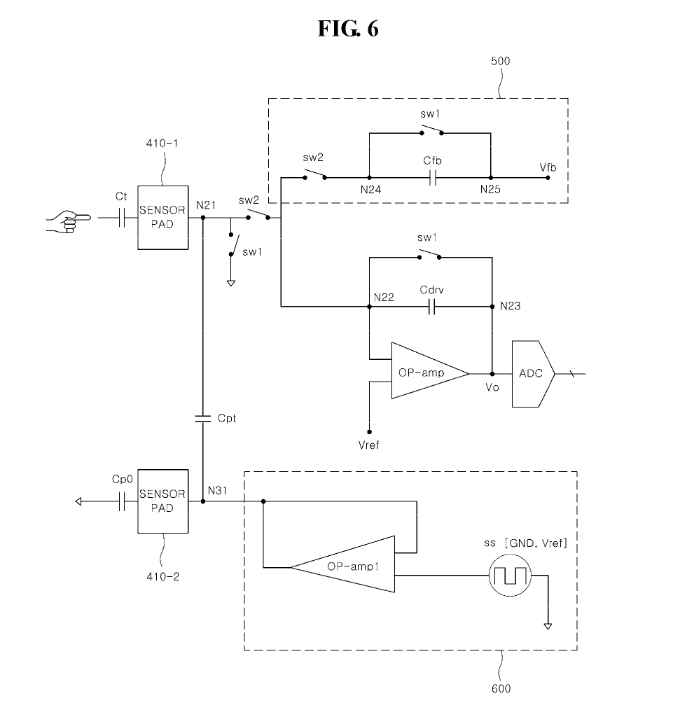

FIG. 6 is a circuit diagram exemplifying an apparatus for detecting touch according to another embodiment of the present invention.

Referring to FIG. 6, the apparatus for detecting touch may include the parasitic capacitance compensation circuit 500 together with the parasitic capacitance elimination circuit 600.

The parasitic capacitance elimination circuit 600 eliminates the parasitic capacitance Cpt generated between the adjacent sensor pads. Thus, the size of feedback capacitance Cfb may have a smaller value than the embodiment illustrated in FIG. 4. That is, since the amount of charge supplied by the parasitic capacitance compensation circuit 500 to the parasitic capacitance Cpt and Cp0 decreases, an area which the feedback capacitance Cfb occupies may be minimized in terms of circuit configuration.

Although the exemplary embodiments of the present disclosure have been disclosed for illustrative purposes, those skilled in the art will appreciate that various modifications, additions and substitutions are possible, without departing from the scope and spirit of the present disclosure as disclosed in the accompanying claims. Therefore, it should be understood that the forgoing description is by way of example only, and is not intended to limit the present disclosure. For example, each constituent explained in singular form may be carried out being dispersed, and likewise, constituents explained as being dispersed may be carried out in combined forms.

The scope of the present disclosure is defined by the foregoing claims, and it is intended that the present disclosure covers the modifications or variations of the present disclosure provided they come within the scope of the appended claims and their equivalents.

1. An apparatus for detecting touch, comprising:
a sensor pad for forming touch capacitance in relation to a touch input tool;
an operation amplifier for outputting different signals according to whether there is touch on the sensor pad, the operation amplifier having a first input end connected to the sensor pad and a second input end receiving a reference voltage;
a first switch for controlling potential of both ends of driving capacitance connected between the first input end and an output end of the operation amplifier;
a second switch for switching a connection between the sensor pad and the first input end, the second switch being turned on and off alternately with the first switch; and
a parasitic capacitance compensation circuit for supplying an electric charge to at least one of the touch capacitance and parasitic capacitance that shares the amount of charge of the touch capacitance when the second switch is in an on state.

2. The apparatus of claim 1, wherein, when the second switch is in an on state, the amount of charge supplied by the parasitic capacitance compensation circuit is the same as an amount of charge charged in the parasitic capacitance.

3. The apparatus of claim 1, wherein, when the second switch is in an on state, one end of the parasitic capacitance compensation circuit is connected to the sensor pad and another end includes a feedback capacitance supplying a feedback voltage.

4. The apparatus of claim 3, wherein the potential of both ends of the feedback capacitance is controlled by a third switch synchronized with the first switch.

5. The apparatus of claim 3, wherein the size of the feedback capacitance, when touch is not made in the sensor pad, is set not to make a voltage change in the output end of the operation amplifier when the first switch is in an on state and when the second switch is in an on state.

6. The apparatus of claim 1, further comprising a level shift detection unit detecting whether there is touch based on a voltage change at the output end of the operation amplifier.

7. An apparatus for detecting touch, comprising:
a plurality of sensor pads for forming touch capacitance in relation to a touch input tool, and outputting a sensing signal according to touch state;
an operation amplifier for outputting different signals based on the sensing signal, the operation amplifier having a first input end connected to the output end of the first sensor pad and a second input end receiving a reference voltage;
a first switch for controlling potential of both ends of driving capacitance connected between the first input end and an output end of the operation amplifier;
a second switch for switching a connection between the output end of the first sensor pad and the first input end, the second switch being turned on and off alternately with the first switch; and
a parasitic capacitance elimination circuit for supplying the same potential as the output end of the first sensor pad to a second sensor pad which is adjacent to the first sensor pad.

8. The apparatus of claim 7, wherein the parasitic capacitance elimination circuit supplies the same potential as the potential of the output end of the first sensor pad to the second sensor pad, the parasitic capacitance elimination circuit being synchronized with an on/off of the first switch and the second switch.

9. The apparatus of claim 8, wherein the parasitic capacitance elimination circuit supplies a ground voltage and the reference voltage, respectively, to the second sensor pad when the first switch and the second switch are in an on state.

10. The apparatus of claim 7, wherein the parasitic capacitance elimination circuit comprises a feedback operation amplifier receiving the same signal as the potential of the output end of the first sensor pad to supply it to the second sensor pad.

11. A method for detecting touch, comprising:
resetting a sensor pad, parasitic capacitance connected to the sensor pad, and driving capacitance connected between a first input end of an operation amplifier and an output end;
charging at least one of parasitic capacitance connected to the sensor pad and touch capacitance formed between the sensor pad and a touch input tool based on a reference voltage applied to the second input end of the operation amplifier and a feedback voltage of the operation amplifier; and
detecting whether there is touch based on a voltage change at the output end of the operation amplifier,
wherein the charging supplies an electric charge so that the touch capacitance could have the voltage change and linearity irrelevant to the parasitic capacitance.

12. The method of claim 11, wherein the charging compensates charge loss by the parasitic capacitance through feedback capacitance to which the feedback voltage applies, and wherein the reference voltage applied by the operation amplifier is only associated with the touch capacitance and driving capacitance.

13. The method of claim 11, wherein, when the feedback voltage is N times the reference voltage, the feedback capacitance is a divided value of parasitic capacitance by N−1.

14. A method for detecting touch, comprising:
resetting at least one first sensor pad which is the subject of touch detection among a plurality of sensor pads and driving capacitance connected between a first input end and an output end of an operation amplifier;
charging the first sensor pad using a reference voltage applied to a second input end of the operation amplifier; and
detecting whether there is touch based on a voltage change at the output end of the operation amplifier,
wherein the resetting and charging comprise, respectively, comprise supplying the same potential as the output end of the first sensor pad to the second sensor pad which is adjacent to the first sensor pad.

15. The method of claim 14, wherein the resetting comprises supplying a ground voltage to the second sensor pad, wherein the charging comprises supplying a voltage with the same size as the reference voltage to the second sensor pad.

16. An apparatus for detecting touch, comprising:
a sensor pad for forming touch capacitance in a relation with a touch input tool;
a first switch which is in an on state only when the sensor pad is reset, the first switch being connected between the sensor pad and a ground terminal;
an operation amplifier for outputting a touch detection signal, the operation amplifier having a first input end connected to the sensor pad and a second input end to which a reference voltage is applied;
driving capacitance connected between the first input end and the output end of the operation amplifier;
a second switch which is in an on state only when the sensor pad is reset, the second switch being connected to both ends of the driving capacitance;
feedback capacitance whose one end is connected to the sensor pad and the feedback voltage is applied to another end;
a third switch connected between the sensor pad and the first input end of the operation amplifier, the third switch being turned on and off alternately with the first switch and the second switch;
a fourth switch connected between the sensor pad and the feedback capacitance, the fourth switch being turned on and off alternately with the first switch and the second switch; and
a fifth switch which is in an on state only when the sensor pad is reset, the fifth switch being connected between both ends of the feedback capacitance.

17. An apparatus for detecting touch, comprising:
a plurality of sensor pads for forming touch capacitance in a relation with a touch input tool, and outputting a sensing signal according to touch state;
a first switch which is in an on state only when the sensor pad is reset, the first switch being connected between a first sensor pad, which is the subject of touch detection among the plurality of sensor pads, and a ground terminal;
an operation amplifier for outputting different signals based on the sensing signal, the operation amplifier having a first input end connected to the first sensor pad and a second input end to which a reference voltage is applied;
driving capacitance connected between the first input end and the output end of the operation amplifier;
a second switch which is in an on state only when the sensor pad is reset, the second switch being connected to both ends of the driving capacitance;
a third switch connected between the sensor pad and the first input end of the operation amplifier, the third switch being turned on and off alternately with the first switch and the second switch; and
a feedback operation amplifier where a first input end is connected with the same node as an output end to connect to the second sensor pad which is adjacent to the first sensor pad, and the ground voltage and a voltage with the same potential as the reference voltage are alternately applied to the second input end.
